(19) United States
(12) Patent Application Publication
(10) Pub. No.: US 2011/0011504 A1
(43) Pub. Date: Jan. 20, 2011

(54) Handbag accessory including stealth pet lash

(76) Inventor: Robin Steinbacher, Georgetown, TX (US)

Correspondence Address: Christopher J. Whewell;Western Patent Group, 6020 Tonkowa Trail, Georgetown, TX, 78628, US

(21) Appl. No.: 12/460,284

(22) Filed: Jul. 16, 2009

(51) Int. Cl. A45C 15/00; A45C 13/30; A45C 13/10; A01K 27/00

(52) U.S. Cl. 150/106; 150/107; 150/118; 119/792

(57) ABSTRACT

Handbags useful for carrying and containing various and sundry items typically carried in handbags are provided with added capability of functioning as a pet leash. A tether suitable as a leash is attached to a handbag as provided herein, ensuring a pet-owning user is never without a leash for their pet when traveling or other activities including shopping. A tether as provided and structured herein additionally conveniently functions as a shoulder strap for a handbag and in alternate configurations may be hidden from view by being tucked inside the main pouch of such handbags, when they are used as a clutch.

### TECHNICAL FIELD

This invention relates generally to accessory handbags, purses and the like commonly carried. More particularly, it relates to accessory handbags which also comprise a leash tether useful for controlling a pet, which leash may be conveniently hidden within such handbags and which handbags provide for the leash to have a dual function as a carrying strap for the handbags.

### BACKGROUND OF THE INVENTION

For centuries people have carried handbags in various forms, for stowing and convenience in transportation of various and sundry items placed within such handbags. In modern times, handbags, purses, clutches and the like are commonly carried predominantly but not exclusively by those of the female gender, to contain such items as wallets, make-up, weapons, keys, etc.

Persons fond of pets, including without limitation dogs and cats, frequently prefer that their pets accompany them during their daily activities. since daily activities often include travel to locations at which it is desirable or necessary to constrain a pet to the control of a leash, such pet owners typically also carry a leash that is adapted or configured to be removably attached to their pet's collar. Being a stand-alone item, as are reading glasses, leashes are similarly susceptible to being mis-placed or lost by their owners.

### SUMMARY OF THE INVENTION

Handbags useful for carrying various and sundry items and also having functionality as a pet leash are provided. A handbag according to the disclosure comprises a pouch portion having an opening provided with a closure that is configured to cover the opening. There is also a tether having a length, a first end portion, and a second end portion. The tether is attached at more than one point, and preferably at a plurality of successive points along a chosen segment of its length equal to at least half the length of the handbag, to the handbag substantially at the opening of the pouch portion. The tether further includes a clasp configured to be removably attached to a pet collar disposed at the first end portion of the tether.

### BRIEF DESCRIPTION OF THE DRAWINGS

Embodiments of invention may take physical form in certain elements and arrangement of elements, the preferred embodiment of which is described in detail in this specification and illustrated as necessary in the accompanying drawings which form a part hereof, and wherein:

FIG. 1 shows a perspective view of a handbag according to one embodiment of the disclosure in an open configuration;

FIG. 2 shows a perspective view of a handbag according to one embodiment of the disclosure in a closed configuration;

FIG. 3 shows a perspective view of a handbag according to one embodiment of the disclosure in a closed configuration with a tether concealed inside the handbag;

FIG. 4 shows a perspective view of a handbag according to one embodiment of the disclosure in a closed configuration with a tether and hand strap concealed inside the handbag;

FIG. 5 shows a perspective view of a handbag according to an alternate embodiment of the disclosure in an open configuration;

FIG. 6 shows a perspective view of a handbag according to another embodiment of the disclosure in an open configuration;

FIG. 7 shows a perspective view of a handbag according to the embodiment shown in FIG. 6 in a closed configuration; and

FIG. 8 shows a perspective view of a handbag according to an alternate embodiment of the disclosure in an open configuration.

### DETAILED DESCRIPTION INCLUDING PREFERRED EMBODIMENT

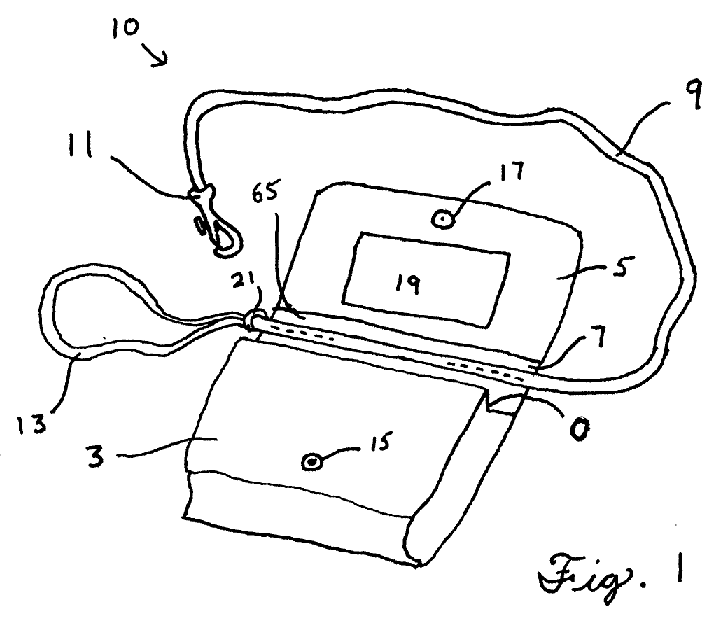

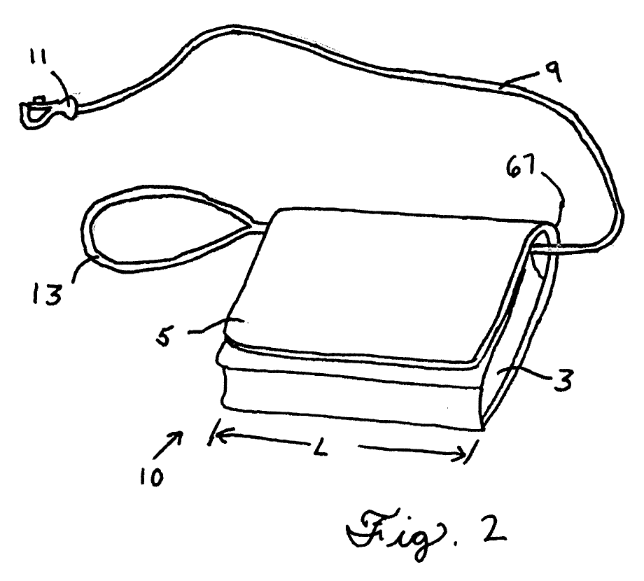

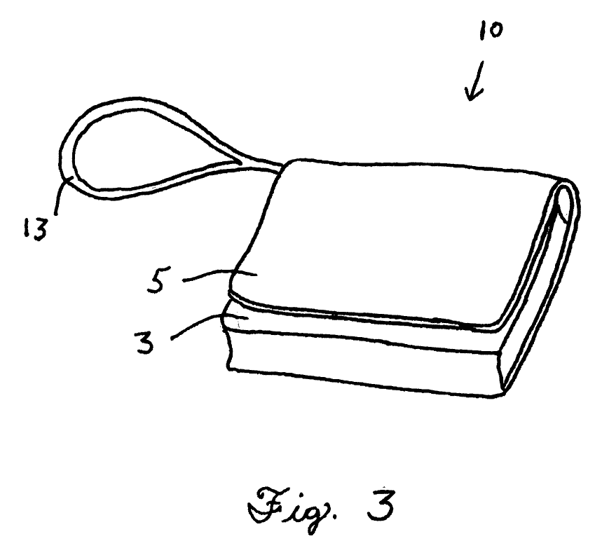

Referring now to the drawings, wherein the showings are for the purpose of illustrating the invention only and not for the purpose of limiting the same, FIG. 1 shows perspective view of a handbag 10 according to one embodiment of the disclosure in an open configuration. In this embodiment handbag 10 comprises a pouch portion 3 having an opening O, that enables access to an interior volume within the pouch portion 3 in which various and sundry items may be carried, as is common typical for handbags. There is a flap closure 5 that is hingeably attached to the pouch portion 3 at hinge 7, which enables access to opening O to be blocked when the flap closure 5 is folded over onto the pouch portion 3 such that first clasp portion 15 and second clasp portion 17 are able to engage with one another and maintain the flap closure 5 in a closed position, such closed position being shown in FIGS. 2 and 3. The hinge 7 in one embodiment is comprised of the same piece of fabric as is the flap closure 5 and rear wall of pouch portion 3, which provides ease in manufacture of such closable pouch structures which are generally known in the art. “Fabric” as used in this specification and the claims appended hereto includes all materials known to be used or useful in constructing handbags, including without limitation cloth fabric, leathers, polymeric fabric including woven, non-woven, and sheet materials. Thus, in some embodiments a closure is provided which comprises a flap closure hingedly attached to the handbag at a hinged portion (hinge 7), and wherein the tether is attached to the handbag substantially along the hinged portion on the inner face 65 (FIG. 1) of the hinge, hinge 7 also having an exterior surface 67 (FIG. 2).

The first clasp portion 15 and second clasp portion 17 may comprise any pair of complementary fasteners known in the art as being useful for maintaining a flap closure 5 in a reasonably securely closed orientation with respect to the pouch portion 3, and include without limitation such complementary fasteners as magnetic fasteners, hook-and-loop fasteners, buttons, and snaps.

There is also a tether 9, which may comprise any cord, rope, strap, etc. which is generally recognized or recognizable in the art as being useful as being capable of functioning as a dog leash. These include without limitation braided, woven or single-strand ropes, twines, straps, leather straps, polypropylene cords, and nylon cords, whether substantially-flat or of any cross-sectional shape. Tether 9 has a first end portion at which is attached a clasp 11 that is configured to be easily removably attached to a pet's collar, as such clasps are well-known in the art. The second end portion of tether 9 is provided with a hand strap 13, which in one embodiment comprises a looping of the tether 9, being maintained in a loop by any convenient and known means, such as by being appropriately stitched to itself. In the embodiment of FIG. 1, the tether 9 is attached to handbag 10 along the hinge 7 substantially at the location as shown, by any conventional attachment including rivets, fasteners, and stitching to the handbag 10 at its hinge 7, such that the hand strap 13 is present adjacent to hinge 7. Although not shown in the drawings, in one embodiment the hand strap 13 is disposed between two layers of fabric present along hinge 7, to conceal most of the portion of tether 9 that is present along hinge 7 from view. In a preferred embodiment there is an attachment loop 21 to which the clasp 11 may be removably attached at the desire of the user. Attachment loop 21 may be any secure continuous construct capable of holding the clasp 11 in a fixed position at the location of the attachment loop 21. In a preferred embodiment attachment loop 21 is a metallic ring that is attached to the handbag 10 at the location shown in FIG. 1 by a strap of fabric that is itself stitched to handbag 10. Thus, in this embodiment the location at which the tether element is attached to the handbag is on the interior of the closure, yet at the exterior of the opening O. Stitching is shown in FIG. 1 at the dashed lines. Although shown present on two segments of the tether, the stitching may optionally extend entirely along the segment of the tether that is present along the inner surface 65 of hinge 7, but in any event is an effective amount of attachment (stitching, snaps, zippers, etc.) to maintain the tether to be attached to the handbag.

Such a construct as described is capable of being configured for use in different ways. In a first configuration, such as that shown in FIG. 2, a closed configuration is provided in which the tether 9, clasp 11, and hand strap 13 are disposed on the exterior of the handbag. In this configuration, the clasp 11 may be attached to the collar of a pet such as for example when a person carrying the handbag 10 desires to enter an area where pets are required to be, or are desirably restrained. The user may hold the handbag 10 by the hand strap 13 with their pet attached to the clasp 11, and use the handbag as one would an ordinary dog leash. Also labeled in FIG. 2 is the length L of the handbag 10.

Another configuration of the handbag 10 shown and described in reference to FIGS. 1 and 2 is depicted in the configuration shown in FIG. 3 in which tether 9 is concealed inside the handbag 10. In this configuration, a person may use handbag 10 as an ordinary handbag to carry various and sundry items, without any observer knowing that the handbag actually contains pet leash functionality. One advantage of such a configuration is that as long as the person has the handbag 10 in their possession, they also possess an effective pet leash which may not be lost owing to the tether 9 being substantially permanently attached to the handbag 10 at the hinge 7. In such a configuration, a user may go about their normal business until a time presents itself to employ a pet leash, at which time clap closure 5 is opened, the concealed portion of the tether 9 is removed from the opening O of the handbag and clasp 11 is attached to the pets collar.

An alternate configuration of handbag 10 of FIGS. 1, 2, 3 is where clasp 11 is attached to attachment loop 21 and the hand strap 13 is placed inside the handbag 10. In such a configuration the handbag 10 appears as an ordinary handbag having a strap that may be hung over one's shoulders as the handbag 10 is carried about. A handbag 10 as shown in FIG. 1 may include all various features known to be present on handbags in general, including a vanity mirror 21.

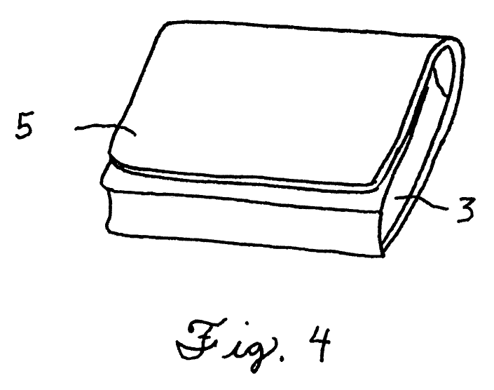

FIG. 4 shows a perspective view of the handbag 10 of FIGS. 1, 2, 3 in a configuration wherein tether 9 and hand strap 13 are both concealed inside the handbag 10 and flap closure 5 is in its closed position.

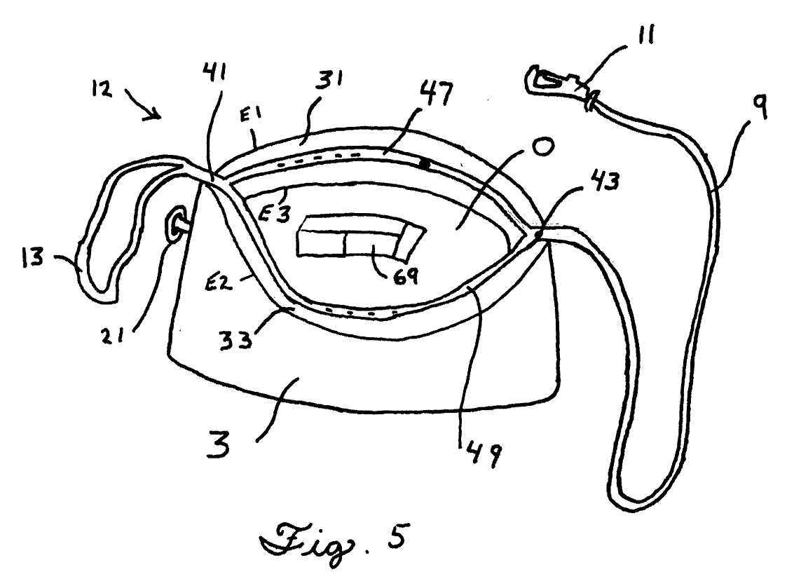

In FIG. 5 is shown a perspective view of a handbag 12 according to an alternate embodiment of the disclosure in an open configuration. In this embodiment handbag 12 is substantially rectangular when viewed from a side perspective, comprising in general two rectangular panels of fabric which are attached to one another along three of their edges but not their fourth, to provide a selectively closeable opening O as shown that enables access to the volume present between the panels. Collectively, these panels form a pouch portion 3 which typically inherently comprises a first rim margin area 31 and a second rim margin area 33, which rim margin areas are merely the first inch or so of fabric on the interior of the pouch portion 3 within opening O leading into the interior volume of the pouch 3. The rim margin areas may in some embodiments be optionally provided with a sheathing layer of fabric material that may or may not differ from the fabric material from which the pouch portion 3 is comprised. The pouch portion 3 further comprises a first edge E1 and a second edge E2, as shown, which are the top edges of each of the respective panels. There is a tether 9 having a first end and a second end, with the first end being provided with a clasp configured to readily and removably attach to a ring present on a pet's collar or an attachment loop 21, as desired. The second end of tether 9 is provided with a hand strap for a user to grasp onto and hold in their hand. In this embodiment, tether 9 is split along a distance of its length portion substantially equal to the overall width of pouch 3 and adjacent to hand strap 13. This splitting of tether 9 yields a first tether length 47 and a second tether length 49, which are each part of tether 9 in one embodiment. First tether length 47 is attached to pouch 3 at first rim margin area 31 using conventional attachment, which in one embodiment comprises stitching (shown) first tether length 47 to first rim marginal area 31 along the length of first tether length 47. Second tether length 49 is attached to pouch 3 at second margin area 33 using conventional attachment, which in one embodiment comprises stitching (shown) second tether length 49 to first rim marginal area 33 along the length of second tether length 49. The attachment of the tether lengths to the rim margins may be done so that the tether lengths are visible, or optionally so that they are obscured from view by being disposed between two sheets of fabric, in one embodiment comprising one of the panels from which pouch 3 is constructed and the rim margin material. It is preferable that tether 9 is attached to pouch 3 at the points 41, 43 using conventional attachment as mentioned herein including stitching, snaps, etc for added strength when using handbag 12 as a pet leash. In preferred embodiments first edge E1 and second edge E2 are provided with a structure for closing the opening O, protecting the contents of pouch 3 from falling out such as when pouch 3 is inverted. Such structures suitable include the presence of the complementary halves of a zipper, each being disposed substantially along first edge E1 and second edge E2, or optionally at or on the first and second rim margin areas so the pouch 3 may be conveniently zipped open or zipped shut at opening O, as desired, thus providing a closure for a handbag useful in many embodiments provided herein. Typically the interior of pouch 3 is provided with pockets 69 and an attachment loop 21 present in the vicinity of the hand strap 13 on the edge of pouch 3.

Thus, the structure shown in FIG. 5 provides for handbag 12 to exist in various configurations, a first configuration beginning with that shown in FIG. 5 wherein one or both of the portion of tether 9 having clasp 11 at its end portion and hand strap 13 may be conveniently tucked into the opening O and into the volume within handbag 12, opening O subsequently being secured or fastened in a closed position, and handbag 12 being carried as a “clutch”. In an alternate configuration, opening O of handbag 12 shown in FIG. 5 is closed by zipping closed a zipper having its half portions attached to pouch 3 along first edge E1 and second edge E2, or optionally at or on the first and second rim margin areas, and handbag 12 is employed as a pet leash by attaching clasp 11 to a pet's collar, the user grasping hand strap 13. In a further alternate configuration, only hand strap 13 is present on the exterior of pouch 3 and handbag 12 may be carried by hand strap 13. In a further configuration of the handbag 12 of FIG. 5, clasp 11 is attached to attachment loop 21 and the hand strap 13 is placed into pouch 3, the opening being subsequently closed and handbag 12 may then be carried by slinging tether 9 about the user's shoulders. Thus, handbag 12 of FIG. 5 appears in some of its possible configurations as a typical handbag accessory, but stealthily conceals pet leash structure and functionality, as well as versatility in its ability to be used as a clutch or shoulder-carry item.

Moreover, in the embodiment of FIG. 5 and others similar, the location at which the tether is attached to the handbag can be on or at the exterior to the closure and exterior to the opening. This is the case when for example a zipper is attached at or proximal to the line E3 in FIG. 5, which extends all the way around the opening beneath the location at which the first and second tether lengths are attached. In alternate embodiments, the location at which the tether is attached to the handbag can be on or at the interior of the closure and interior to the opening. This is the case when for example a zipper is attached at or proximal to the first and second edges E1, E2 of FIG. 5.

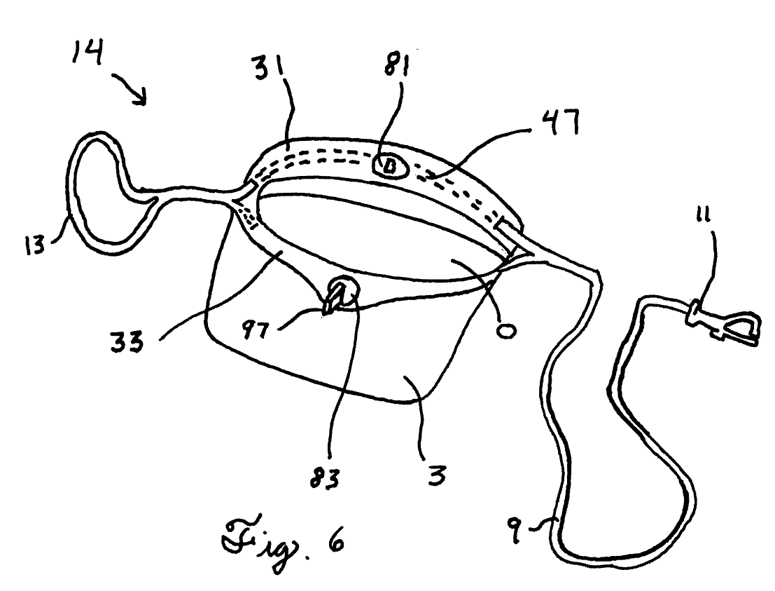

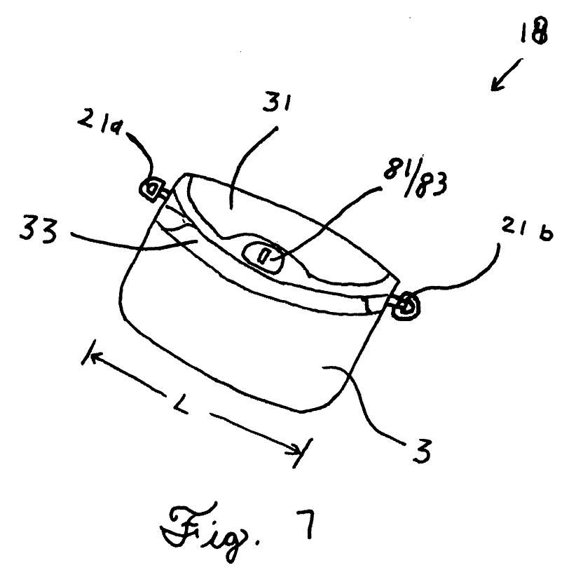

FIG. 6 shows a perspective view of a handbag 14 according to another embodiment of the disclosure in an open configuration, which is substantially the same as the embodiment shown and described in reference to FIG. 5, excepting that a different type of first clasp and second clasp are provided, and the handbag 14 is in this embodiment closed by folding one of the rim margin areas over the other. That is, to close the opening O the first rim margin 31 having a hole at 81 that is configured to receive a complementary clasp 97 shaped substantially as a rectangular or other solid shape and rotably disposed at escutcheon 83, as such complementary clasps are known in the art, is folded over to receive clasp 97 into hole 81, and clasp 97 is rotated about 90 degrees to secure the rim portions in a closed configuration, as shown in the embodiment depicted in FIG. 7. In the embodiment shown in FIG. 6 a portion of the first tether length 47 is shown by dashed line, as it is present between two layers of fabric and not visible when the margin areas are disposed so opening O is in an open position. In this embodiment the tether 9 is not attached at points 41, 43 as was present in the embodiment of FIG. 5. The respective locations of pouch portion 3, and hand strap 13 are shown. Not shown but optionally present is attachment loop 21. Uses and capabilities of this handbag 14 are shared by the embodiments shown and described in reference to FIG. 1.

FIG. 7 shows a perspective view of a handbag 18 having an opening/closing mechanism as described in reference to the embodiment of FIG. 6 in a closed configuration. In this embodiment there is no hand strap 13 or tether 9 shown, rather attachment loops 21a and 21b attached to each side of the handbag 18. These attachment loops allow for attachment of a tether 9 having a clasp 11 disposed at each of its two ends to handbag 18 to both a pet and either attachment loop 21a or 21b, and also a hand strap 13 having a clasp 11 attached to it, which may be clipped on the remaining attachment loop 21am 21b to which tether 9 is not attached. By such an arrangement, the preferences of both right-handed and left-handed persons relative to the opening of the handbag may be accommodated. Also labeled in FIG. 7 is the length L of handbag 18.

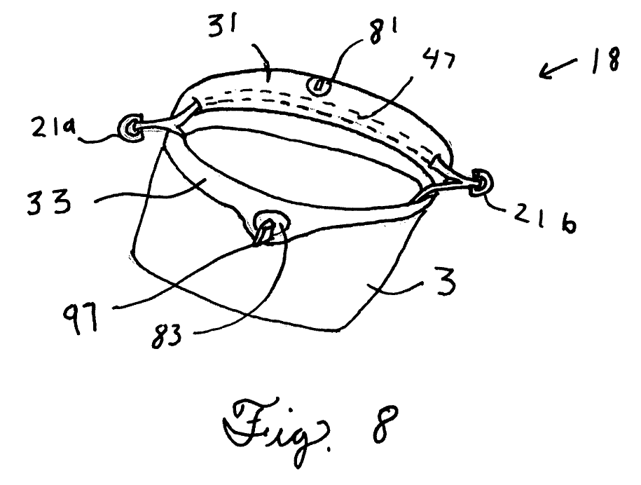

FIG. 8 shows a perspective view of a handbag 18 according to the embodiment of FIG. 7 in an open configuration. Here, the first tether length 47 is attached to the handbag in the shown position such as by stitching and is disposed beneath a layer of fabric and is depicted by the dashed lines. Although not shown completely there is a second tether length 49 as was the case in the embodiment of FIG. 5, and also attached to the handbag as is shown in reference to the first tether length 47 such as by stitching, also being disposed-beneath a layer of fabric so as to not be readily visible. The first tether length 47 and second tether length 49 join together at each of their ends and after joining are terminated at attachment loops 21a and 21b. In one embodiment such a construct of a split tether is provided by beginning with a single tether of any selected width deemed suitable, which is split down the middle of its length, for a length that is slightly less than the overall opening of the handbag. Then each of the first and second lengths are sewn or stitched to the handbag itself in substantially the location shown.

In various embodiments, the tether is attached at more than one point, and preferably at a plurality of successive points along any chosen segment of the length of the tether in an effective amount to secure the tether to the handbag, substantially at the opening of the pouch portion. In preferred embodiments, the segment is chosen to be disposed adjacent to hand strap 13. In some embodiments, the segment of the tether that is attached to the handbag is within about 10 cm from the hand strap 13, and the length of the segment of the tether that is attached to the handbag is any segment along the tether having a length of between about two centimeters and up to the length of the handbag as defined in FIGS. 2 and 7, but is most typically between about two centimeters and about thirty centimeters, including all lengths and ranges of lengths therebetween. In a preferred embodiment, the distance between successive points in a plurality of points at which said tether is attached to said handbag is less than about one centimeter. In other embodiments, the distance between successive points in a plurality of points at which said tether is attached to said handbag is any distance between about one centimeter and about one-half the length L of said handbag as such length is defined in FIGS. 2 and 7. In some embodiments, the tether is attached to the handbag by means of snaps having one complementary counterpart affixed to the handbag at locations described herein for attachment of the tether, the other complementary counterpart of such snaps being affixed to the tether. In some embodiments, any other known conventional attachment means are employed in the stead of such snaps as referred to immediately above.

In various embodiments, the tether is attached at more than one point, and preferably at a plurality of successive points along any chosen segment of the length of the tether, to the handbag substantially at the opening of the pouch portion. In some embodiments the length of this segment is equal to at least half the length of the handbag.

Consideration must be given to the fact that although this invention has been described and disclosed in relation to certain preferred embodiments, equivalent modifications and alterations thereof may become apparent to persons of ordinary skill in this art after reading and understanding the teachings of this specification, drawings, and the claims appended hereto. The present disclosure includes subject matter defined by any combinations of any one or more of the features provided in this disclosure with any one or more of any other features provided in this disclosure to arrive at an article as described having the same or substantially the same functionality. These combinations include the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. These combinations also include combination of the features and/or limitations of one or more of the independent claims with features and/or limitations of another independent claims to arrive at a modified independent claim, with the remaining dependent claims in their original text or as modified per the foregoing, being read and applied to any independent claim so modified. The present invention has been disclosed and claimed with the intent to cover modifications and alterations that achieve substantially the same result as herein taught using substantially the same or similar structures, being limited only by the scope of the claims which follow.

1. Handbag useful for carrying various and sundry items and also having functionality as a pet leash, comprising:
a pouch portion having an opening provided with a closure configured to cover said opening;
a tether having a length, a first end portion, and a second end portion, said tether being attached along its length to said handbag substantially at said opening; and
a clasp configured to be removably attached to a pet collar attached to said first end portion of said tether.

2. Handbag according to claim 1 wherein the location at which said tether is attached to said handbag is on the interior of said closure and the exterior of said opening.

3. Handbag according to claim 1 wherein the location at which said tether is attached to said handbag is on the interior of said closure and the interior of said opening.

4. Handbag according to claim 1 wherein the location at which said tether is attached to said handbag is on the exterior of said closure and the exterior of said opening.

5. Handbag according to claim 1 further comprising a hand strap disposed at said second end portion of said tether.

6. Handbag according to claim 1 comprising fabric disposed over said tether in an effective amount so that when said opening is closed in normal usage of said handbag, the length of tether attached to said handbag is substantially obscured from view.

7. Handbag according to claim 1 wherein said closure comprises a flap closure hingedly attached to said handbag at a hinged portion, and wherein said tether is attached to said handbag substantially along said hinged portion on the inner face of said hinged portion.

8. Handbag according to claim 1 wherein said opening comprises a first rim margin and a second rim margin, and wherein said tether comprises a first tether length attached to said first rim margin and a second tether length attached to said second rim margin.

9. Handbag according to claim 1 further comprising at least one attachment loop present on said handbag at any location exterior to said opening.

10. Handbag according to claim 9 dimensioned and configured sufficiently to enable said tether to function both as a shoulder strap for said handbag and as a concealable pet leash wherein none of said tether is visible when concealed within said pouch.

11. Handbag according to claim 1 wherein said closure comprises a zipper.

12. Handbag according to claim 1 wherein said closure comprises a clasp including a pair of complementary elements.

13. Handbag according to claim 1 wherein said tether is attached to said handbag at a plurality of points along any selected segment of said tether.

14. Handbag according to claim 13 wherein the distance between two points of said plurality is less than about one centimeter.

15. Handbag according to claim 5 wherein said tether is attached to said handbag at a plurality of points along any selected segment of said tether, the segment of said tether being disposed within a distance less than about one-half the length of the handbag with respect to the location of said hand strap.

16. Handbag according to claim 5 wherein said tether is attached to said handbag at a plurality of points along any selected segment of said tether, the segment of said tether being disposed within a distance less than about one-fourth the length of the handbag with respect to the location of said hand strap.

17. Handbag according to claim 5 wherein each of said hand strap and said tether are selectively removable from said handbag.

18. Handbag according to claim 17 wherein said hand strap and said tether are attached to said handbag by means of clasps.

19. Handbag according to claim 18 wherein said at least one of said clasps engages an attachment loop present on said handbag.
